(19) United States
(12) Patent Application Publication
(10) Pub. No.: US 2012/0195297 A1
(43) Pub. Date: Aug. 2, 2012

(54) WIRELESS COMMUNICATION APPARATUS, INFORMATION PROCESSING APPARATUS, AND METHOD FOR CONTROLLING ANTENNA OF INFORMATION PROCESSING APPARATUS

(75) Inventor: Kazuya Fukushima, Hamura-shi (JP)

(73) Assignee: KABUSHIKI KAISHA TOSHIBA, Tokyo (JP)

(21) Appl. No.: 13/310,671

(22) Filed: Dec. 2, 2011

(30) Foreign Application Priority Data
Jan. 28, 2011 (JP) 2011-016319

(51) Int. Cl. H04W 88/02

(52) U.S. Cl. 370/338

(57) ABSTRACT

According to one embodiment, a wireless communication apparatus includes a plurality of connectors, a plurality of amplifiers and a plurality of amplifier controllers. The plurality of amplifiers amplify outputs from a plurality of antennas connected to the plurality of connectors, respectively. The plurality of amplifier controllers control gains of the plurality of amplifiers, respectively. Each of the plurality of amplifier controllers comprises a determination module, a notification module and a gain adjustment module. The determination module determines a reception status of a corresponding one of the plurality of antennas. The notification module notifies one or more other amplifier controllers of the reception status determined by the determination module. The gain adjustment module adjusts a gain of the corresponding one of the plurality of amplifiers based on the reception status notified from the one or more other amplifier controllers.

### CROSS-REFERENCE TO RELATED APPLICATIONS

This application is based upon and claims the benefit of priority from prior Japanese Patent Application No. 2011-016319, filed Jan. 28, 2011, the entire contents of which are incorporated herein by reference.

### FIELD

Embodiments described herein relate generally to a wireless communication apparatus, an information processing apparatus, and a method for controlling an antenna of an information processing apparatus to which, for example, a multiple-input multiple-output (MIMO) technique adopted according to IEEE 802.11n, a standard for wireless local area networks (LANs) is applied.

### BACKGROUND

In recent years, battery-driven highly portable notebook computers have been prevailing widely. Furthermore, public wireless LAN service and the like have been improved. The use of a personal computer equipped with a wireless LAN function allows a user to carry out, for example, transmission and reception of electronic mails and browsing of Web pages even while the user is out of doors.

Wireless LANs use radio for communication, and thus the reception sensitivity of relevant antennas needs to be kept at a level where the antenna can stably receive data. Hence, various mechanisms for improving the reception sensitivity of the antenna have been proposed.

For portable personal computers such as notebook computers, the time for which the computer can be continuously driven by batteries is very important. Thus, many mechanisms for power saving are incorporated into such personal computers.

Therefore, the reception sensitivity of the antenna is preferably adaptively controlled with power saving taken into account, instead of being simply improved. For example, the reception sensitivity of the antenna is adjusted to the minimum value required for data reception.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an appearance of an information processing apparatus according to an embodiment.

FIG. 2 is an exemplary diagram showing a system configuration of the information processing apparatus according to the embodiment.

FIG. 3 is an exemplary diagram showing a configuration of a wireless communication module mounted in the information processing apparatus according to the embodiment.

FIG. 4 is an exemplary first diagram illustrating an operation of the wireless communication module mounted in the information processing apparatus according to the embodiment.

FIG. 5 is an exemplary second diagram illustrating the operation of the wireless communication module mounted in the information processing apparatus according to the embodiment.

FIG. 6 is an exemplary flowchart illustrating an example of a procedure of a process for setting a gain for a power amplifier which process is carried out by a MAC controller in the wireless communication module mounted in the information processing apparatus according to the embodiment.

FIG. 7 is an exemplary diagram illustrating a concept of a process for adjusting a gain of the power amplifier which process is carried out by the MAC controller in the wireless communication module mounted in the information processing apparatus according to the embodiment.

FIG. 8 is an exemplary flowchart illustrating an example of a procedure of a process for adjusting a gain for the power amplifier which process is carried out by the MAC controller in the wireless communication module mounted in the information processing apparatus according to the embodiment.

### DETAILED DESCRIPTION

Various embodiments will be described hereinafter with reference to the accompanying drawings.

In general, according to one embodiment, a wireless communication apparatus includes a plurality of connectors, a plurality of amplifiers and a plurality of amplifier controllers. The plurality of amplifiers are configured to amplify outputs from a plurality of antennas connected to the plurality of connectors, respectively. The plurality of amplifier controllers are configured to control gains of the plurality of amplifiers, respectively. Each of the plurality of amplifier controllers comprises a determination module, a notification module and a gain adjustment module. The determination module is configured to determine a reception status of a corresponding one of the plurality of antennas. The notification module is configured to notify one or more other amplifier controllers of the reception status determined by the determination module. The gain adjustment module is configured to adjust a gain of the corresponding one of the plurality of amplifiers based on the reception status notified from the one or more other amplifier controllers.

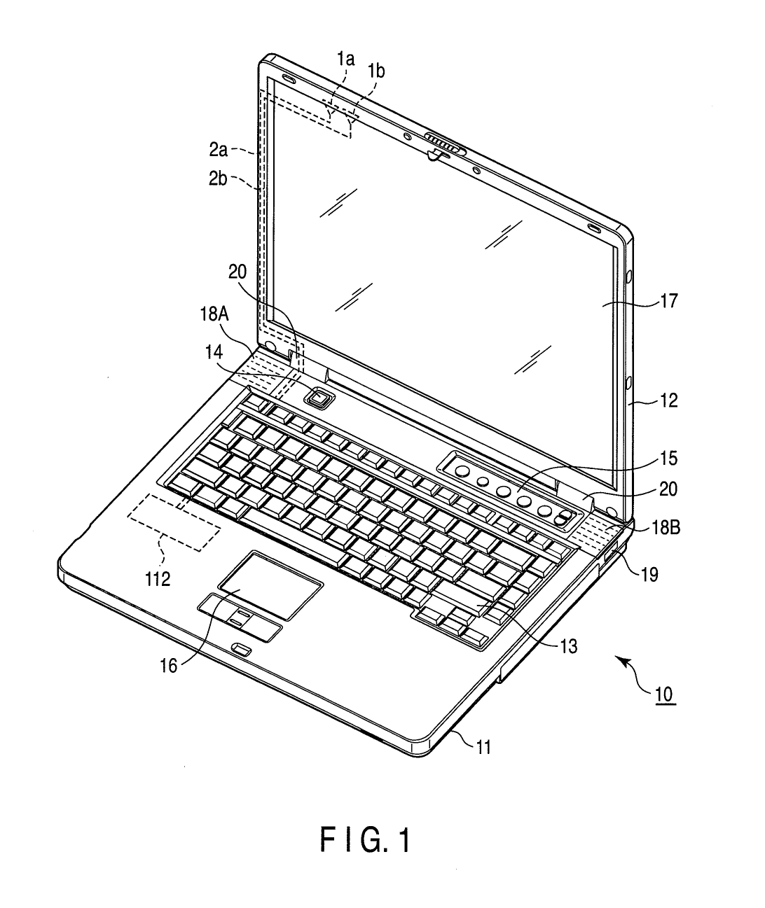

FIG. 1 is an exemplary diagram showing an appearance of an information processing apparatus according to the embodiment. The information processing apparatus is implemented as, for example, a notebook computer 10 that can be driven by batteries and which is equipped with a wireless LAN function.

FIG. 1 is a perspective view showing that a display unit of a computer 10 is open. The computer 10 includes a computer main body 11 and the display unit 12. A liquid crystal display (LCD) 17 is incorporated in the display unit 12. A display screen of the LCD 12 is positioned almost in the center of the display unit 12.

The display unit 12 is pivotally rotatably attached to the computer main body 11 via a hinge portion 20. The hinge portion 20 is a coupling portion via which the display unit 12 is coupled to the computer main body 11. That is, the display unit 12 is supported by the hinge portion 20 arranged at a rear end of the computer main body 11. The display unit 12 is attached to the computer main body 11 by the hinge portion 20 so as to be pivotally rotatable between an open position where the top surface of the computer main body 11 is exposed and a closed position where the top surface of the computer main body 11 is covered with the display unit 12.

The computer main body 11 is a base unit with a thin box-shaped enclosure. The computer main body 11 includes a keyboard 13, a power button 14, an input operation panel 15, a touch pad 16, and speakers 18A and 18B all arranged on the top surface thereof; the power button 14 is used to power on and off the computer 10. Various operation buttons are provided on the input operation panel 15.

Furthermore, a system board (also referred to as a motherboard) with various electronic components thereon is provided inside the computer main body 11. A wireless communication module 112 is installed on the system board to provide a wireless LAN function. The wireless communication module 112 uses, for example, a MIMO technique adopted according to IEEE 802.11n, a standard for wireless LANs to communicate wirelessly with external devices. The wireless communication module 112 includes an antenna terminal configured to transmit and receive radio (RF) signals.

The antenna terminal is coupled to antennas 1a and 1b provided, for example, at the upper end of the display unit 12, by signal lines 2a and 2b extended from the computer main body 11 into the display unit 12 via the hinge portion 20. Since the antennas 1a and 1b are provided at the upper end of the display unit 12, the wireless communication module 112 can communicate wirelessly with external device with the antennas 1a and 1b arranged at a relatively high position.

Furthermore, a USB connector 19 is provided on the right side surface of the computer main body 11 so that a USB cable or a USB device which is compatible with, for example, the universal serial bus (USB) 2.0 standard, can be connected to the USB connector 19.

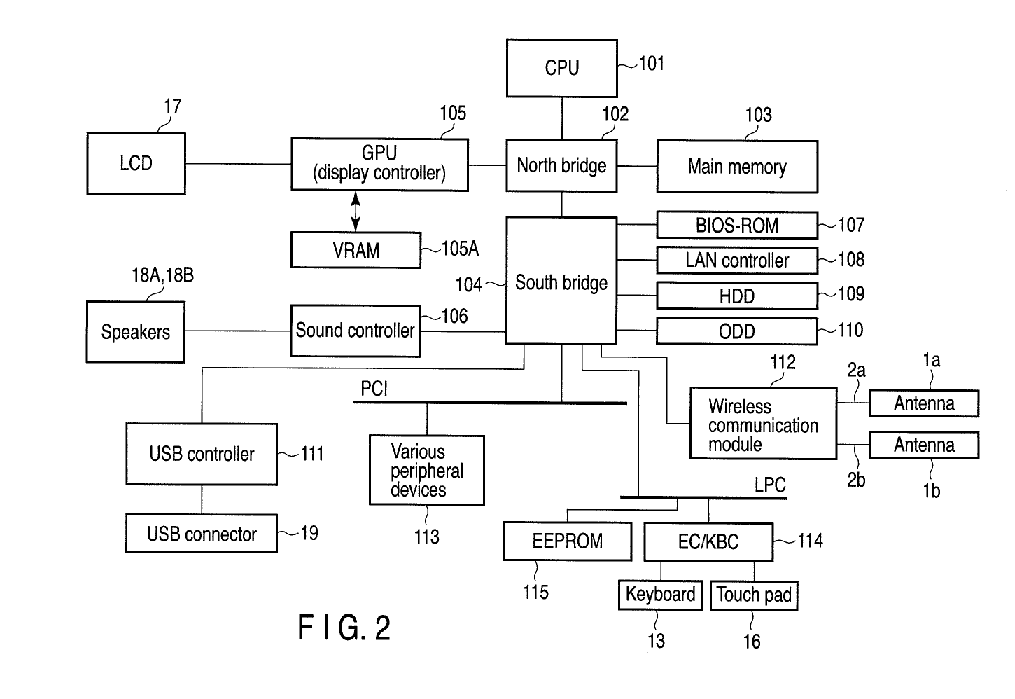

FIG. 2 is an exemplary diagram showing a system configuration of the computer 10.

As shown in FIG. 2, the computer 10 includes a central processing unit (CPU) 101, a north bridge 102, a main memory 103, a south bridge 104, a graphics processing unit (GPU) 105, and a video random access memory (VRAM) 105A. The computer 10 further includes a sound controller 106, a basic input/output system read-only memory (BIOS-ROM) 107, a LAN controller 108, a hard disk drive (HDD) 109, and an optical disc drive (ODD). Moreover, the computer 10 includes a USB controller 111, the wireless communication module 112, various peripheral devices 113, an embedded controller/keyboard controller (EC/KBC) 114, and an electrically erasable programmable controller (EEPROM) 115.

The CPU 101 is a processor configured to control the operation of portions in the computer 10. The CPU 101 executes an operating system (OS), various application programs, and the like which are loaded from the HDD 109 into the main memory 103. The CPU 101 also executes the BIOS stored in the BIOS-ROM 107. The BIOS is a program for controlling hardware.

The north bridge 102 is a bridge device configured to connect a local bus of the CPU 101 and the south bridge 104 together. The north bridge 102 also contains a memory controller configured to control accesses to the main memory 103. Furthermore, the north bridge 102 functions to communicate with the GPU 105 via a serial bus according to, for example, the PCI EXPRESS standard.

The GPU 105 is a display controller configured to control the LCD 17 used as a display monitor for the computer 10. Display signals generated by the GPU 105 are transmitted to the LCD 17.

The south bridge 104 controls the various peripheral devices 113 on a peripheral component interconnect (PCI) bus. Furthermore, the south bridge 104 contains an integrated drive electronics (IDE) controller configured to control the HDD 109 and ODD 110. Moreover, the south bridge 104 functions to communicate with the sound controller 106, the LAN controller 108, the USB controller 111, and the wireless communication module 112.

The sound controller 106 is a sound source device and outputs audio data to be reproduced, to speakers 18A and 18B. The LAN controller 108 is a wired communication apparatus configured to communicate by wire according to, for example, the IEEE 802.3 standard. The USB controller 111 communicates with an external device (a USB device connected to the USB controller 111 via the USB connector 19) compatible with, for example, the USB 2.0 standard.

EC/KBC 114 is a 1-chip microcomputer with an embedded controller and a keyboard controller integrated therein; the embedded controller is configured to manage power, and the keyboard controller is configured to control the keyboard 13 and the touch pad 16. EC/KBC 114 functions to power on and off the computer 10 in accordance with the user's operation of the power button 14.

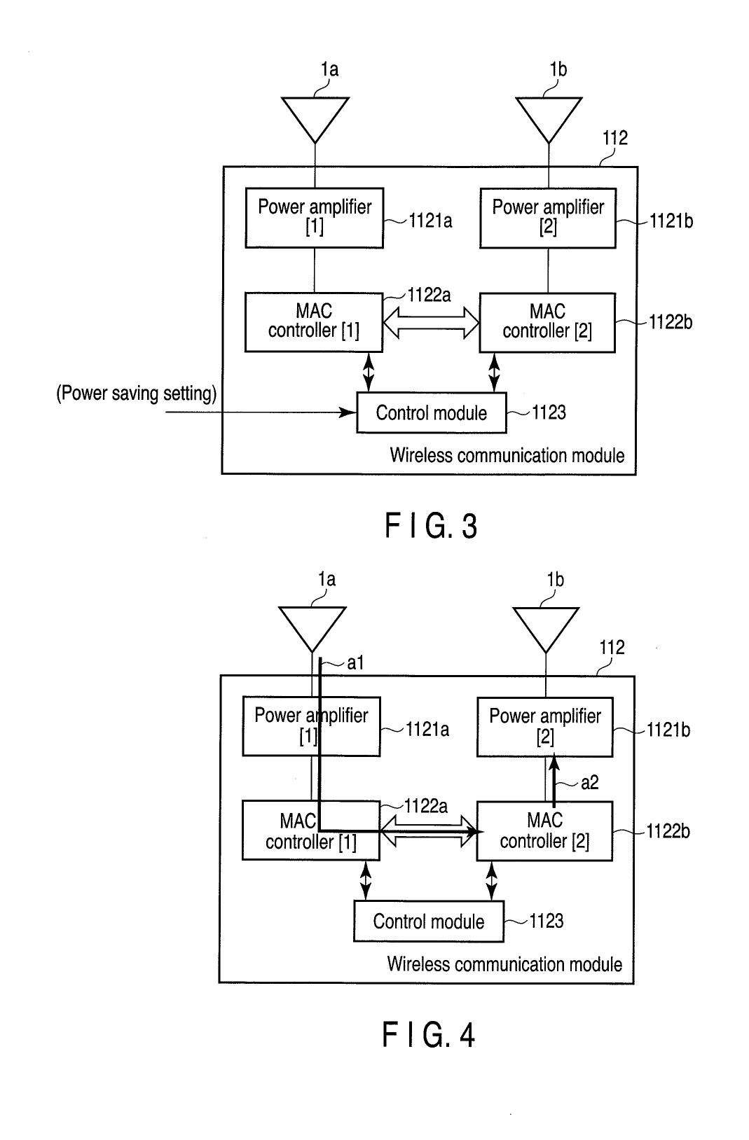

FIG. 3 is an exemplary diagram showing a configuration of the wireless communication module 112.

As shown in FIG. 3, the wireless communication module 112 includes two amplifiers 1121a and 1121b, two media access control (MAC) controllers 1122a and 1122b, and a control module 1123. Furthermore, as shown FIG. 3, the antennas 1a and 1b are connected to the power amplifiers 1121a and 1121b, respectively. The antennas 1a and 1b are hereinafter sometimes collectively referred to as the antenna 1. The power amplifiers 1121a and 1121b are hereinafter sometimes collectively referred to as the power amplifier 1121. The MAC controllers 1122a and 1122b are hereinafter sometimes collectively referred to as the MAC controller 1122.

Each of the power amplifiers 1121a and 1121b contains automatic gain control (AGC [a reception amplifier]) configured to adjust reception sensitivity. Thus, the reception sensitivities of the antennas 1a and 1b can be individually improved by controlling the gains of the power amplifiers 1121a and 1121b, respectively. Power amplifiers of wireless communication modules are normally configured to be able to roughly set the gain at one of about three levels, for example, a high level, a medium level, and a low level. In contrast, the power amplifiers 1121a and 1121b of the wireless communication module 112 adopted in the present embodiment are of a type that can increase and reduce the gain in small steps of 1 to 2 dB.

The MAC controllers 1122a and 1122b control the gains of the power amplifiers 1121a and 1121b, respectively. Furthermore, the MAC controllers 1122a and 1122b function to communicate with each other. The power consumption of the wireless communication module 112 is subject to the power consumption of the power amplifiers 1121a and 1121b. Thus, in the wireless communication module 112 in the present embodiment, the two MAC controllers 1122a and 1122b collaboratively control the gains of the power amplifiers 1121a and 1121b (which can increase and reduce the gain in small steps of 1 to 2 dB). Thus, the reception sensitivity of the antenna can be adaptively controlled with power saving taken into account. This will be described below.

The control module 1123 is an interface portion configured to accept the power saving setting to transmit the contents of the setting to the MAC controllers 1122a and 1122b. When not set for power saving, the wireless communication module 112 gives preference to an increase in the speed of data communication over the power saving. The wireless communication module 112 thus transmits and receives data using the two antennas 1a and 1b. On the other hand, when set for power saving, the wireless communication module 112 gives preference to power saving over an increase in the speed of data communication. The wireless communication module 112 thus transmits and receives data using one of the two antennas 1a and 1b. The MAC controllers 1122a and 1122b take the power saving setting into account in controlling the power amplifiers 1121a and 1121b.

When the wireless communication module 112 is powered on, the MAC controllers 1122a and 1122b set the gains of the power amplifiers 1121a and 1121b, respectively, to predetermined initial values. The initial values are statistically calculated assuming various situations (for example, the distance to a device with which the wireless communication module 112 communicates). The initial values are at an average threshold level at which the corresponding reception sensitivity of the antenna is sufficient to receive data or at a slightly lower level.

Here, it is assumed that one of the two power amplifiers 1121a and 1121b, that is, the power amplifier 1121a, is in control. After the wireless communication module 112 is powered on and the MAC controllers 1122a and 1122b then set the gains of the power amplifiers 1121a and 1121b to the initial values, when the wireless communication module 112 starts communication, the power amplifier 1121a, which is in control, first checks the antenna 1a for a radio-signal reception status (sensitivity). FIG. 4 is an exemplary diagram illustrating an operation of the wireless communication module 112.

Now, it is assumed that the antenna 1a cannot receive radio signals (because the initial value is at the relatively low level). In this case, the MAC controller 1122a notifies the MAC controller 1122b of “NG” (“a1” in FIG. 4). On the other hand, upon receiving the notification of “NG”, the MAC controller 1122b increases the gain of the power amplifier 1121b by one step (“a2” in FIG. 4).

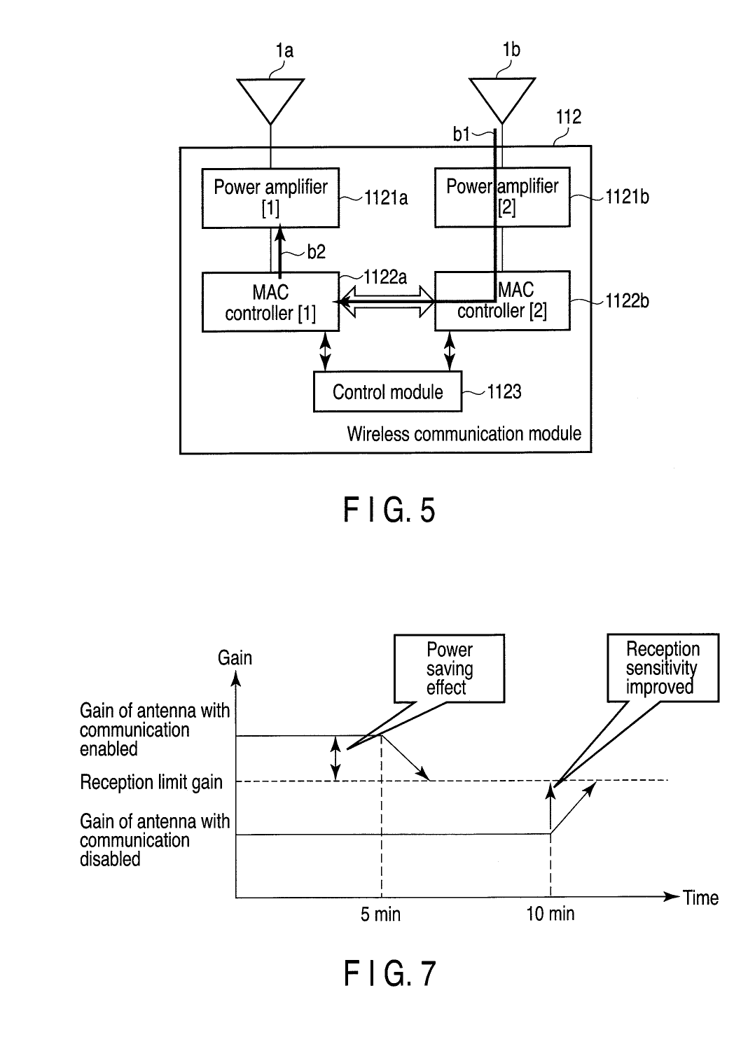

Furthermore, after receiving the notification of “NG” and then increasing the gain of the power amplifier 1121b by one step, the MAC controller 1122b checks the antenna 1b for the radio-signal reception status (sensitivity) similarly to the MAC controller 1122a. FIG. 5 is an exemplary diagram illustrating the operation of the wireless communication module 112 performed at this time.

Also in this case, it is assumed that the antenna 1b is not enabled to receive radio signals. Then, the MAC controller 1122b notifies the MAC controller 1122a of “NG” (“b1” in FIG. 5). Then, after receiving the notification of “NG”, the MAC controller 1122a increases the gain of the power amplifier 1121a (“b2” in FIG. 5).

Subsequently, the MAC controllers 1122a and 1122b cooperate with each other in continuing the operation illustrated in FIG. 4 and FIG. 5. Thus, the gains of the power amplifiers 1121a and 1122b increase alternately by one step. This makes one of the antennas 1a and 1b enabled to receive radio signals (both antennas 1a and 1b if the initial gains allow radio signals to be received).

One of the MAC controllers 1122 which includes the antenna 1 connected thereto and enabled to receive radio signals notifies the other MAC controller 1122 of “OK”. For example, assuming that the antenna 1b is enabled to receive radio signals, the MAC controller 1122b notifies the MAC controller 1122a of “OK”.

Upon receiving the notification of “OK”, the antenna 1a is not enabled to receive radio signals yet. Here, the MAC controller 1122a checks whether or not the wireless communication module 112 is set for power saving. If the wireless communication module 112 is set for power saving, the MAC controller 1122a notifies the MAC controller 1122b of “NG” without increasing the gain of the power amplifier 1121a (even though the antenna 1a is disabled to receive radio signals). The MAC controller 1122b recognizes that the antenna 1b is enabled to receive radio signals, and thus avoids increasing the gain of the power amplifier 1121b even upon receiving the notification of “NG”.

As a result, communication using one of the antennas 1a and 1b (in this case, the antenna 1b) is established. That is, the wireless communication module 112 is enabled to transmit and receive data using one of the two antennas 1a and 1b. Furthermore, the gain of the power amplifier 1121 of the antenna 1 that is now enabled to receive radio signals is set to the minimum required value. Thus, the wireless communication module 112 achieves communication with the minimum power consumption when set for power saving.

On the other hand, when the wireless communication module 112 is not set for power saving, the MAC controller 1122a consecutively increases the gain of the power amplifier 1121a by one step until the antenna 1a is enabled to receive radio signals. Then, communication using both antennas 1a and 1b is established. That is, the wireless communication module 112 is enabled to transmit and receive data using the two antennas 1a and 1b. Also in this case, the gain of the power amplifier 1121 of each of the two antennas 1 enabled to receive radio signals is set to the minimum required value. Thus, the wireless communication module 112 achieves communication with the minimum power consumption, with preference given to an increase in the speed of data communication.

As described above, in the wireless communication module 112 in the present embodiment (to which the antennas 1a and 1b are connected), each of the MAC controllers 1122a and 1122b sets the minimum gain required for reception, for the corresponding one of the power amplifiers 1121a and 1121b, while checking one of the antennas connected to the MAC controller for the reception sensitivity. Furthermore, the MAC controllers 1122a and 1122b check whether one or both of the two antennas are to be used for reception in determining the gains of the power amplifiers 1121a and 1121b. As a result, the power amplifiers 1121a and 1121b can be operated with the minimum required power consumption.

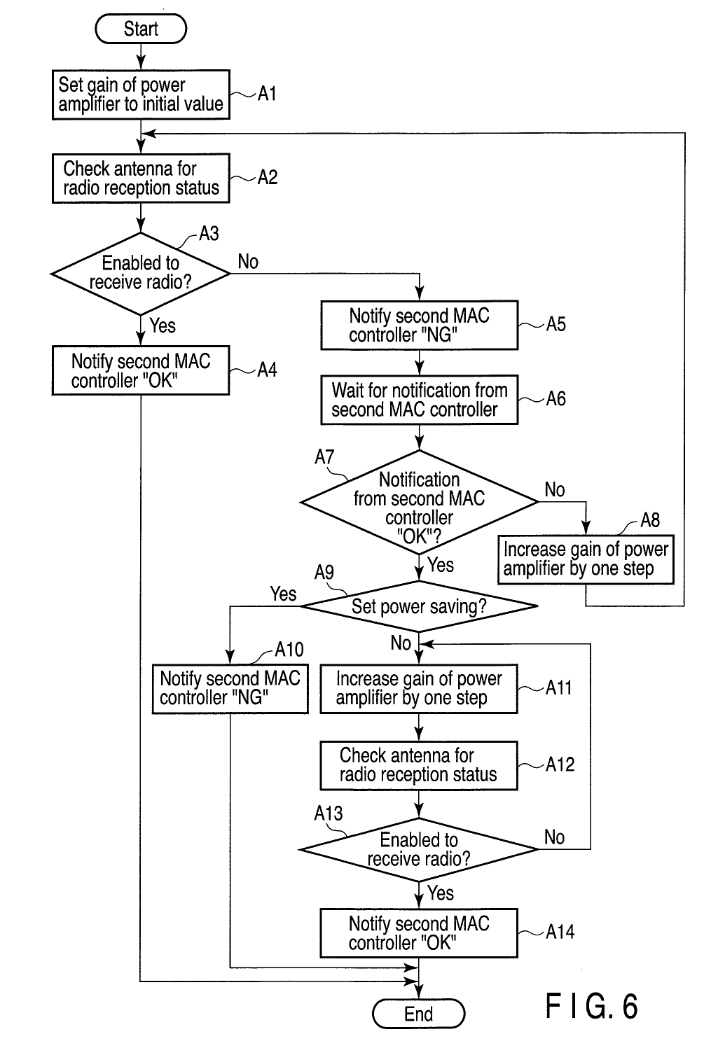

FIG. 6 is an exemplary flowchart illustrating an example of a procedure of a process for setting a gain of the power amplifier 1121 which process is carried out by the MAC controller 1122.

When the wireless communication module 112 is powered on, each of the MAC controller 1122 sets the gain of the power amplifier 1121 to the initial value (block A1). Thereafter, when the wireless communication module 112 starts communication, the MAC controller 1122 (which is in control) checks the antenna 1 for the radio-signal reception status (block A2).

If the antenna 1 is enabled to receive radio signals (YES in block A2), the MAC controller 1122 notifies the other MAC controller 1122 of “OK” (block A3). The MAC controller 1122 thus ends the process for setting the gain of the power amplifier 1121. On the other hand, if the antenna 1 is disabled to receive radio signals (NO in block A3), the MAC controller 1122 notifies the other MAC controller of “NG” (block A5). The MAC controller 1122 then waits for notification from the other MAC controller 1122 (block A6). The MAC controller 1122 (which is not in control) sets the gain of the power amplifier 1121 to the initial value in block A1, and then shifts to block A6 to wait for notification. After block A6 where the MAC controller 1122 waits for notification, the process procedure is the same for all the MAC controllers 1122.

If the other MAC controller 1122 gives the notification of “NG” (NO in block A7), the MAC controller 1122 increases the gain of the power amplifier 1121 by one step (block A8). The MAC controller 1122 then checks the antenna 1 for the power reception status (block A2). Then, if the antenna 1 is enabled to receive radio signals (YES in block A2), the MAC controller 1122 notifies the other MAC controller 1122 of “OK” (block A4). The MAC controller 1122 thus ends the process for setting the gain of the power amplifier 1121. If the antenna 1 is disabled to receive radio signals (NO in block A3), the MAC controller 1122 notifies the other MAC controller 1122 of “NG” (block A5). The MAC controller 1122 then waits for notification from the other MAC controller 1122 (block A6).

That is, until one of the MAC controllers 1122 gives notification of “OK”, the processing from block A6 to block A5 (block A6, NO in block A7, block A8, block A2, NO in block A3, and block A5) is alternately carried out between the MAC controllers 1122. Thus, the gain of the power amplifier 1121 increases in steps.

If the other MAC controller 1122 notifies the MAC controller 1122 of “OK” (YES in block A7), the MAC controller 1122 checks whether or not the wireless communication module 112 is set for power saving (block A9). If the wireless communication module 112 is set for power saving (YES in block A9), the MAC controller 1122 notifies the other MAC controller 1122 of “NG” without increasing the gain of the power amplifier 1121 (even though the antenna 1 is disabled to receive radio signals) (block A5). The MAC controller 1122 thus ends the process for setting the gain of the power amplifier 1121. Thus, the wireless communication module 112 carries out communication via one of the antennas 1 (with the reception sensitivity thereof set to the minimum required value).

On the other hand, if the wireless communication module 112 is not set for power saving (NO in block A9), the MAC controller 1122 increases the gain of the power amplifier 1121 by one step (block A11). The MAC controller 1122 then checks the antenna 1 for the radio-signal reception status (block A12). The MAC controller 1122 repeats the processing in blocks A11 and A12 until the antenna 1 is enabled to receive radio signals. When the antenna 1 is enabled to receive radio signals (YES in block A13), the MAC controller 1122 notifies the other MAC controller 1122 of “OK” (block A14). The MAC controller 1122 thus ends the process for setting the gain of the power amplifier 1121. Thus, the wireless communication module 112 carries out communication via the two antennas 1 (with the reception sensitivity thereof set to the minimum required value).

As described above, first, the wireless communication module 112 in the present embodiment adopts the power amplifier 1121 that can increase and reduce the gain in small steps of 1 to 2 dB. Second, the wireless communication module 112 in the present embodiment is configured such that the MAC controllers 1122, which control the gain of the power amplifier 1121, collaboratively increase the gain. This enables the reception sensitivity of the antenna to be adaptively controlled with power saving taken into account.

Furthermore, in order to further save power, the MAC controller 1122 of the wireless communication module 112 in the present embodiment carries out a process for adjusting the gain of the power amplifier 1121 at predetermined intervals. FIG. 7 is an exemplary diagram illustrating a concept of a process for adjusting a gain of the power amplifier 1121 which process is carried out by the MAC controller 1122.

Here, it is assumed that the MAC controller 1122 carries out the process for adjusting the gain of the power amplifier 1121 at intervals of five minutes. If the situation has changed compared to that prevailing five minutes earlier, for example, the distance to the device with which the wireless communication module 112 communicates has been reduced, the antenna 1 may be kept enabled to receive radio signals even with a decrease in the gain of the power amplifier 1121. Thus, the MAC controller 1122 carries out a process for reducing the gain of the power amplifier 1121 in steps if the antenna 1 is enabled to receive radio signals.

Furthermore, the MAC controller 1122 carries out a process for increasing the gain of the power amplifier 1121 in steps if the antenna 1 is disabled to receive radio signals. It is assumed that with the wireless communication module 112 set for power saving, the situation changes compared to that prevailing five minutes earlier, for example, the distance to the device with which the wireless communication module 112 communicates is increased. In this case, for the antenna 1 used to establish communication, the gain of the power amplifier 1121 is increased in immediate response to the change in situation. This results in a difference in reception sensitivity between the two antennas 1.

Thus, in order to eliminate the difference, the MAC controller 1122 carries out the process for increasing the gain of the power amplifier 1121 in steps if the antenna 1 is disabled to receive radio signals. This enables a shift to be quickly completed when, for example, the power supply setting is canceled (the shift is such that the two antennas 1 are enabled to receive radio signals at the minimum required reception sensitivity).

That is, the following results are expected when the MAC controller 1122 periodically carries out the process for adjusting the gain of the power amplifier 1121. As illustrated in FIG. 7, power can be saved for the antenna 1 enabled to receive radio signals, whereas the reception sensitivity can be increased for the antenna 1 disabled to receive radio signals.

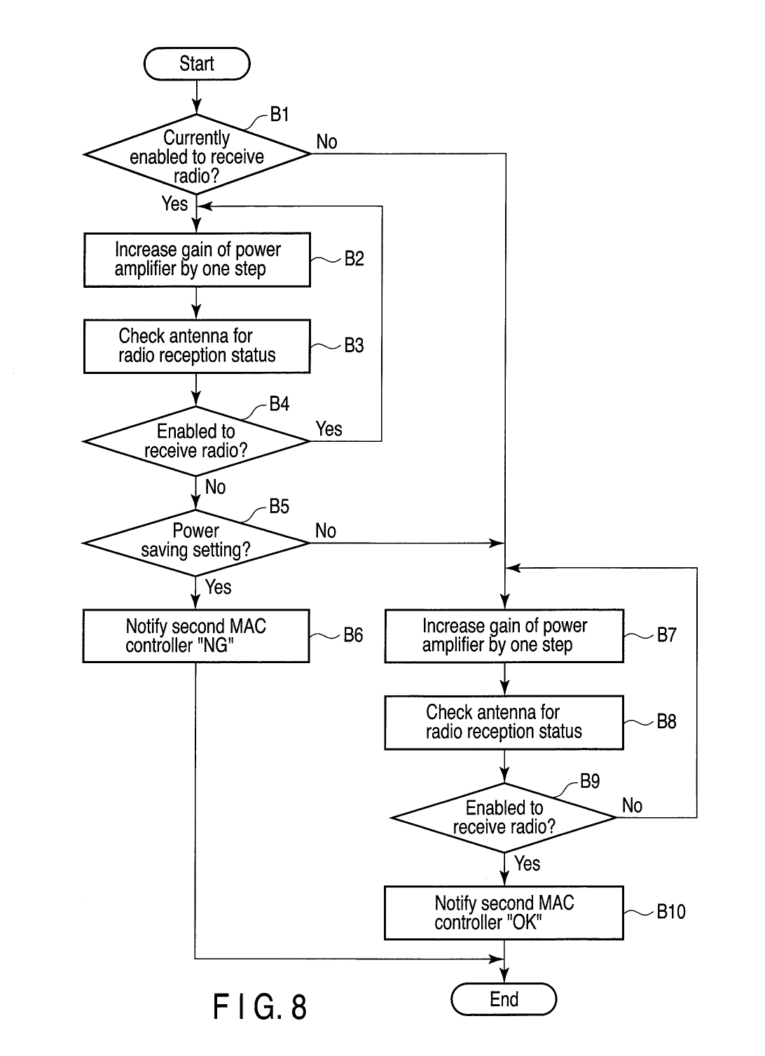

FIG. 8 is an exemplary flowchart illustrating an example of the procedure of the process for adjusting a gain of the power amplifier 1121 which process is carried out by the MAC controller 1122.

If the antenna 1 is enabled to receive radio signals during execution of the process for adjusting the gain (YES in block B1), the MAC controller 1122 reduces the gain of the power amplifier 1121 by one step (block B2). The MAC controller 1122 then checks the antenna 1 for the radio-signal reception status (block B3). The MAC controller 1122 repeats the processing in blocks B2 and B3 until the antenna 1 is disabled to receive radio signals. Then, when the antenna 1 is disabled to receive radio signals (NO in block B4), the MAC controller 1122 subsequently checks whether or not the wireless communication module 112 is set for power saving (block B5).

If the wireless communication module 112 is set for power saving (YES in block B5), the MAC controller 1122 notifies the other MAC controller 1122 of “NG” (block B6). The MAC controller 1122 thus ends the process for adjusting the gain of the power amplifier 1121. On the other hand, if the wireless communication module 112 is not set for power saving (NO in block B5), the MAC controller 1122 increases the gain of the power amplifier 1121 by one step (block B7). The MAC controller 1122 then checks the antenna 1 for the radio-signal reception status (block B8). The MAC controller 1122 repeats the processing in blocks B7 and B8 until the antenna 1 is enabled to receive radio signals. Then, when the antenna 1 is enabled to receive radio signals (YES in block B9), the MAC controller 1122 notifies the other MAC controller 1122 of “OK” (block B10). The MAC controller 1122 thus ends the process for adjusting the gain of the power amplifier 1121.

Furthermore, if the antenna 1 is disabled to receive radio signals during execution of the process for adjusting the gain (NO in block B1), the MAC controller 1122 increases the gain of the power amplifier 1121 by one step (block B7). The MAC controller 1122 then checks the antenna 1 for the radio-signal reception status (block B8). The MAC controller 1122 repeats the processing in blocks B7 and B8 until the antenna 1 is enabled to receive radio signals. Then, when the antenna 1 is enabled to receive radio signals (YES in block B9), the MAC controller 1122 notifies the other MAC controller 1122 of “OK” (block B10). The MAC controller 1122 thus ends the process for adjusting the gain of the power amplifier 1121.

According to the above-described adjustment process, if the wireless communication module 121 is set for power saving, the reception sensitivity of one of the antennas 1 (which is used to establish communication) is set to the minimum required value, and the reception sensitivity of the other antenna (which is not used to establish communication) is maintained at a level close to the minimum required value. If the wireless communication module 121 is not set for power saving, the reception sensitivity of each of the two antennas 1 is set to the minimum required value.

As described above, according to the wireless communication module in the present embodiment, the reception sensitivity of the antenna can be adaptively controlled with power saving taken into account.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a plurality of connectors to which a plurality of antennas are connected, respectively;
a plurality of amplifiers each paired with a corresponding one of the plurality of connectors, the plurality of amplifiers being configured to amplify outputs from the plurality of antennas, respectively; and
a plurality of amplifier controllers each paired with a corresponding one of the plurality of amplifiers, the plurality of amplifier controllers being configured to control gains of the plurality of amplifiers, respectively,
wherein each of the plurality of amplifier controllers comprises
a determination module configured to determine a reception status of a corresponding one of the plurality of antennas;
a notification module configured to notify one or more other amplifier controllers of the reception status determined by the determination module; and
a gain adjustment module configured to adjust a gain of a corresponding one of the plurality of amplifiers based on the reception status notified from the one or more other amplifier controllers.

2. The apparatus of claim 1, wherein the plurality of amplifier controllers are configured to alternately increase gains of the plurality of amplifiers, in steps starting with an initial value, while notifying the reception status of each other, until any one of the plurality of amplifier controllers issues the reception status indicating that a corresponding one of the plurality of antennas is enabled to carry out reception.

3. The apparatus of claim 2, further comprising a power saving setting module,
wherein each of the plurality of amplifier controllers is configured to notify one or more other amplifier controllers of the reception status indicating that a corresponding one of the plurality of antennas is disabled to carry out reception, without increasing a gain of a corresponding one of the plurality of the amplifiers, if a power saving function is enabled by the power saving setting module, when a corresponding one of the plurality of antennas is disabled to carry out reception and when the reception status indicating that a corresponding one of the plurality of antennas is enabled to carry out reception is received from the one or more other amplifier controllers.

4. The apparatus of claim 3, wherein each of the plurality of amplifier controllers is configured to:
increase a gain of a corresponding one of the plurality of amplifiers, in steps, until a corresponding one of the plurality of antennas comes to be enabled to carry out reception, if the power saving function is disabled, when a corresponding one of the plurality of antennas is disabled to carry out reception and when the reception status indicating that a corresponding one of the plurality of antennas is enabled to carry out reception is received from the one or more other amplifier controllers; and
notify the one or more other amplifier controllers of the reception status indicating that a corresponding one of the plurality of antennas is enabled to carry out reception, when a corresponding one of the plurality of antennas comes to be enabled to carry out reception.

5. The apparatus of claim 4, wherein each of the plurality of amplifier controllers further comprises a gain adjustment module configured to:
reduce a gain of a corresponding one of the plurality of amplifiers, in steps, when a corresponding one of the plurality of antennas is enabled to carry out reception; and
increase a gain of a corresponding one of the plurality of amplifiers, in steps, when a corresponding one of the plurality of antennas is disabled to carry out reception,
at predetermined intervals.

6. The apparatus of claim 5, wherein the gain adjustment module is configured to reduce a gain of a corresponding one of the plurality of amplifiers amplifying output from a corresponding one of the plurality of antennas with reception enabled to an extent that a corresponding one of the plurality of antennas is kept enabled to carry out reception, when the power saving function is disabled.

7. The apparatus of claim 6, wherein the gain adjustment module is configured to:
reduce a gain of a corresponding one of the plurality of amplifiers amplifying output from a corresponding one of the plurality of antennas with reception enabled, until a corresponding one of the plurality of antennas comes to be disabled to carry out reception; and
increase a gain of a corresponding one of the plurality of amplifiers amplifying output from a corresponding one of the plurality of antennas with reception disabled, until a corresponding one of the plurality of antennas comes to be enabled to carry out reception,
when the power saving function is enabled.

8. An information processing apparatus comprising:
a plurality of antennas;
a plurality of amplifiers each paired with a corresponding one of the plurality of antennas, the plurality of amplifiers being configured to amplify outputs from the plurality of antennas, respectively; and
a plurality of amplifier controllers each paired with a corresponding one of the plurality of amplifiers, the plurality of amplifier controllers being configured to control gains of the plurality of amplifiers, respectively,
wherein each of the plurality of amplifier controllers comprises
a determination module configured to determine a reception status of a corresponding one of the plurality of antennas;
a notification module configured to notify one or more other amplifier controllers of the reception status determined by the determination module; and
a gain adjustment module configured to adjust a gain of a corresponding one of the plurality of amplifiers based on the reception status notified from the one or more other amplifier controllers.

9. The apparatus of claim 8, wherein the plurality of amplifier controllers are configured to alternately increase gains of the plurality of amplifiers, in steps starting with an initial value, while notifying the reception status of each other, until any one of the plurality of amplifier controllers issues the reception status indicating that a corresponding one of the plurality of antennas is enabled to carry out reception.

10. The apparatus of claim 9, further comprising a power saving setting module,
wherein each of the plurality of amplifier controllers is configured to notify one or more other amplifier controllers of the reception status indicating that a corresponding one of the plurality of antennas is disabled to carry out reception, without increasing a gain of a corresponding one of the plurality of the amplifiers, if a power saving function is enabled by the power saving setting module, when a corresponding one of the plurality of antennas is disabled to carry out reception and when the reception status indicating that a corresponding one of the plurality of antennas is enabled to carry out reception is received from the one or more other amplifier controllers.

11. The apparatus of claim 10, wherein each of the plurality of amplifier controllers is configured to:
increase a gain of a corresponding one of the plurality of amplifiers, in steps, until a corresponding one of the plurality of antennas comes to be enabled to carry out reception, if the power saving function is disabled, when a corresponding one of the plurality of antennas is disabled to carry out reception and when the reception status indicating that a corresponding one of the plurality of antennas is enabled to carry out reception is received from the one or more other amplifier controllers; and
notify the one or more other amplifier controllers of the reception status indicating that a corresponding one of the plurality of antennas is enabled to carry out reception, when a corresponding one of the plurality of antennas comes to be enabled to carry out reception.

12. The apparatus of claim 11, wherein each of the plurality of amplifier controllers further comprises a gain adjustment module configured to:
reduce a gain of a corresponding one of the plurality of amplifiers, in steps, when a corresponding one of the plurality of antennas is enabled to carry out reception; and
increase a gain of a corresponding one of the plurality of amplifiers, in steps, when a corresponding one of the plurality of antennas is disabled to carry out reception,
at predetermined intervals.

13. The apparatus of claim 12, wherein the gain adjustment module is configured to reduce a gain of a corresponding one of the plurality of amplifiers amplifying output from a corresponding one of the plurality of antennas with reception enabled to an extent that a corresponding one of the plurality of antennas is kept enabled to carry out reception, when the power saving function is disabled.

14. The apparatus of claim 13, wherein the gain adjustment module is configured to:
reduce a gain of a corresponding one of the plurality of amplifiers amplifying output from a corresponding one of the plurality of antennas with reception enabled, until a corresponding one of the plurality of antennas comes to be disabled to carry out reception; and
increase a gain of a corresponding one of the plurality of amplifiers amplifying output from a corresponding one of the plurality of antennas with reception disabled, until a corresponding one of the plurality of antennas comes to be enabled to carry out reception,
when the power saving function is enabled.

15. A method of controlling an antenna for an information processing apparatus comprising a plurality of antennas, a plurality of amplifiers each paired with a corresponding one of the plurality of antennas and configured to amplify outputs from the plurality of antennas, respectively, and a plurality of amplifier controllers each paired with a corresponding one of the plurality of amplifiers and configured to control gains of the plurality of amplifiers, respectively, the method comprising:
alternately increasing gains of the plurality of amplifiers, in steps starting with an initial value, while notifying reception status of a corresponding one of the plurality of antennas to each other, until any one of the plurality amplifier controllers issues the reception status indicating that a corresponding one of the plurality of antennas is enabled to carry out reception.

16. The method of claim 15, further comprising notifying, by each of the plurality of amplifier controllers, one or more other amplifier controllers of the reception status indicating that a corresponding one of the plurality of antennas is disabled to carry out reception, without increasing a gain of a corresponding one of the plurality of amplifiers, if a power saving function is enabled, when a corresponding one of the plurality of antennas is disabled to carry out reception and when the reception status indicating that a corresponding one of the plurality of antennas is enabled to carry out reception is received from the one or more other amplifier controllers.

17. The method of claim 16, further comprising:
Increasing, by each of the plurality of amplifier controllers, a gain of a corresponding one of the plurality of amplifiers, in steps, until a corresponding one of the plurality of antennas comes to be enabled to carry out reception, if the power saving function is disabled, when a corresponding one of the plurality of antennas is disabled to carry out reception and when the reception status indicating that a corresponding one of the plurality of antennas is enabled to carry out reception is received from the one or more other amplifier controllers; and
notifying, by each of the plurality of amplifier controllers, the one or more other amplifier controllers of the reception status indicating that a corresponding one of the plurality of antennas is enabled to carry out reception, when a corresponding one of the plurality of antennas comes to be enabled to carry out reception.

18. The method of claim 17, further comprising:
reducing, by each of the plurality of amplifier controllers, a gain of a corresponding one of the plurality of amplifiers, in steps, when a corresponding one of the plurality of antennas is enabled to carry out reception, at predetermined intervals; and
increasing, by each of the plurality of amplifier controllers, a gain of a corresponding one of the plurality of amplifiers, in steps, when a corresponding one of the plurality of antennas is disabled to carry out reception, at predetermined intervals, by each of the plurality of amplifier controllers.

19. The method of claim 18, further comprising reducing, by each of the plurality of amplifier controllers, a gain of a corresponding one of the plurality of amplifiers amplifying output from a corresponding one of the plurality of antennas with reception enabled to an extent that a corresponding one of the plurality of antennas is kept enabled to carry out reception, when the power saving function is disabled.

20. The method of claim 19, further comprising:
reducing, by each of the plurality of amplifier controllers, a gain of a corresponding one of the plurality of amplifiers amplifying output from a corresponding one of the plurality of antennas with reception enabled, until a corresponding one of the plurality of antennas comes to be disabled to carry out reception, when the power saving function is enabled; and
increasing, by each of the plurality of amplifier controllers, a gain of a corresponding one of the plurality of amplifiers amplifying output from a corresponding one of the plurality of antennas with reception disabled, until a corresponding one of the plurality of antennas comes to be enabled to carry out reception, when the power saving function is enabled.
